(19) United States
(12) Patent Application Publication
(10) Pub. No.: US 2026/0254858 A1
(43) Pub. Date: Aug. 27, 2026

(54) AI-Based Rule Validation for Network Changes

(71) Applicant: Bank of America Corporation, Charlotte, NC (US)

(72) Inventors: Benjamin Pavalon, Chicago, IL (US); Benjamin F. Tweel, Romeoville, IL (US); Frank Yanan, Wheaton, IL (US); Colin Maxwell Behr, Gilberts, IL (US); Aaliyah Williams, Chicago, IL (US); Khushbu Bansal, Bolingbrook, IL (US); Scott Langnas, Chicago, IL (US)

(21) Appl. No.: 19/063,456

(22) Filed: Feb. 26, 2025

(51) Int. Cl. H04L 9/40

(52) U.S. Cl. CPC H04L 63/205; H04L 63/1433

(57) ABSTRACT

An artificial intelligence-driven system and method for validating network rule changes ensures security compliance, mitigates risks, and prevents misconfigurations. The system receives proposed rule changes, validates format and structure, and simulates rule interactions within an existing security configuration. A conflict detection module identifies misconfigurations, while a threat intelligence module retrieves real-time threat data. A risk assessment module extracts risk factors, and an artificial intelligence model computes a risk score to determine automatic approval, rejection, or manual review. A virtualized environment simulates flagged rule changes using synthetic traffic to assess security impact. A feedback module generates a security impact report for administrator review. Approved rules are enforced, while all decisions are logged for compliance tracking. A self-adaptive security module dynamically updates policies based on emerging threats. A machine learning module continuously refines AI-driven risk assessment. This system optimizes network security validation by integrating automation, AI-driven decision-making, and real-time security intelligence.

### TECHNICAL FIELD

The inventions disclosed herein pertain to the field of information security, specifically to automated security policy enforcement and network vulnerability assessment. The invention utilizes artificial intelligence and machine learning to analyze and validate network rule changes in real-time, ensuring that security configurations do not introduce vulnerabilities or conflicts. This technology applies to cybersecurity threat detection, intrusion prevention, and adaptive risk mitigation.

### DESCRIPTION OF THE RELATED ART

Modern network environments are inherently complex and require frequent configuration changes to accommodate new functionalities, such as opening ports, enabling services, or deploying new appliances. These changes are necessary for maintaining efficient operations, but they also introduce security risks that must be carefully managed. Organizations face significant challenges in ensuring that modifications to network rules do not inadvertently create security vulnerabilities, expose sensitive data, or disrupt normal business operations. The validation of these changes is traditionally performed manually, a process that is both time-consuming and error-prone.

As networks evolve, administrators must evaluate each proposed rule modification against an intricate and ever-changing security landscape. The increasing volume and frequency of these changes make it difficult to assess their impact comprehensively. Many organizations lack the ability to systematically analyze how a new rule interacts with existing configurations, leading to the possibility of conflicts, misconfigurations, or toxic rule combinations. This creates an environment where security gaps can persist undetected until they are targeted by attackers.

A significant issue in current network rule validation is the reliance on static, predefined security policies that do not dynamically adjust to emerging threats. These policies are often crafted based on historical security considerations and do not account for new vulnerabilities that may arise. Cyber threats evolve rapidly, and new attack vectors emerge continuously. Without a mechanism for incorporating real-time threat intelligence into rule validation processes, organizations remain vulnerable to sophisticated attacks that target outdated security assumptions.

Another challenge is the lack of integration between network rule validation and external sources of security intelligence, such as vulnerability databases, threat feeds, and cyberattack frameworks like MITRE ATT&CK. Organizations may maintain their own internal rule repositories, but these are often isolated from real-time intelligence updates. This disconnection means that network configurations are assessed based on static criteria rather than current threat landscapes, making it difficult to anticipate and mitigate newly discovered risks.

The manual validation of network rule changes also suffers from inconsistencies due to human error and subjective decision-making. Security administrators may have varying levels of expertise, leading to discrepancies in how rule changes are reviewed and approved. Some changes may be implemented without thorough risk assessment, while others may be unnecessarily delayed due to excessive caution. This inconsistency undermines the efficiency and security of network management, increasing the likelihood of both accidental misconfigurations and operational bottlenecks.

The traditional approach to rule validation also lacks scalability. As organizations grow and their networks become more complex, the number of rule changes that need to be assessed increases exponentially. Security teams often struggle to keep pace with the volume of modifications, leading to delays in rule implementation or oversight in rule interactions. This creates an operational bottleneck where necessary security updates and business-enabling changes are either postponed or applied without adequate scrutiny.

One of the most critical shortcomings of existing network rule validation is the inability to proactively assess risks before changes are deployed. Current methods typically rely on reactive processes, where issues are identified only after they have caused disruptions or security incidents. This means that vulnerabilities may remain undetected until targeted, at which point damage may already have been inflicted. The lack of proactive risk assessment significantly weakens an organization's overall security posture.

Organizations also face challenges in visualizing the impact of rule changes across their entire network. Traditional validation methods do not provide clear insights into rule dependencies, potential conflicts, or the cascading effects of a modification. Security teams must rely on manual reviews and fragmented analysis tools, making it difficult to understand the broader implications of a given rule change. This lack of visibility leads to uncertainty in decision-making and increases the risk of unintended consequences.

Another issue is the difficulty in prioritizing rule modifications based on their risk impact. Without a structured approach to evaluating the security implications of each change, administrators often struggle to determine which modifications require immediate attention and which can be deferred. This results in inefficient allocation of resources, where critical vulnerabilities may be overlooked while low-risk changes consume valuable time and effort. The absence of dynamic risk scoring further exacerbates the inefficiencies of manual validation.

Additionally, network environments often consist of heterogeneous infrastructure, including cloud-based services, on-premises systems, and hybrid architectures. Each of these environments has its own set of security requirements, making it challenging to maintain consistent rule validation processes across different platforms. Current approaches do not effectively account for the unique security contexts of different environments, leading to fragmented and inconsistent validation practices that weaken overall security defenses.

The complexity of modern security architectures also means that network rule changes can have unintended interactions with other security controls. For example, a firewall rule modification may inadvertently override existing security measures, allowing unauthorized access or disrupting legitimate traffic flows. Without a systematic way to simulate and test changes before implementation, organizations run the risk of introducing new vulnerabilities even as they attempt to improve security.

An additional concern is the time and effort required for post-implementation audits and incident response. When rule changes lead to security breaches or operational disruptions, organizations must conduct forensic analysis to identify the root cause of the issue. This reactive approach is both costly and inefficient, as it requires extensive manual investigation and remediation efforts. The lack of automated validation processes increases the time required to resolve security incidents, further exposing organizations to ongoing risks.

Current rule validation methodologies also struggle with explainability and transparency. Security teams must be able to justify and document the rationale behind rule modifications for compliance and auditing purposes. However, manual validation processes often lack structured reporting mechanisms, making it difficult to provide clear documentation of decision-making processes. This creates challenges in regulatory compliance, where organizations must demonstrate adherence to security policies and industry standards.

Furthermore, the increasing sophistication of cyber threats requires a more adaptive and intelligent approach to rule validation. Attackers continually develop new techniques to bypass security controls, and static rule validation frameworks are insufficient in addressing these evolving threats. Organizations need a validation system that not only detects known vulnerabilities but also identifies emerging risks based on behavioral patterns, anomaly detection, and predictive threat modeling.

There has been a long-felt but unmet need for an intelligent, automated solution that can dynamically validate network rule changes while integrating real-time threat intelligence, providing proactive risk assessment, and offering clear visibility into rule interactions. Traditional methods have failed to keep pace with the rapid evolution of cyber threats and the growing complexity of modern networks. Without an automated, AI-driven approach to network rule validation, organizations remain exposed to security risks that could otherwise be mitigated in real time. The industry has lacked a scalable and efficient solution that ensures network security while enabling operational agility, leaving businesses vulnerable to emerging cybersecurity challenges.

### SUMMARY OF THE INVENTION

The invention introduces an intelligent, AI-driven system designed to automatically validate network rule changes in real time, ensuring that each proposed modification maintains or enhances network security while preventing misconfigurations and vulnerabilities. Modern networks require constant adjustments to accommodate evolving business needs, new applications, and emerging security threats. However, traditional methods of rule validation rely on manual review processes, which are prone to human error and often fail to detect complex rule interactions or newly introduced security risks. The invention addresses these challenges by continuously analyzing proposed rule modifications through an automated, intelligence-driven approach, reducing the burden on security teams while increasing accuracy and efficiency.

At the core of the invention is an advanced rule simulation engine that evaluates all possible permutations of a given rule set before changes are applied. This simulation ensures that newly introduced rules do not create conflicts with existing security policies, access controls, or network segmentation configurations. Unlike conventional rule validation processes that rely on static analysis, the system dynamically models how rule changes will impact real-world network traffic and security posture. By conducting comprehensive pre-deployment validation, the invention prevents inadvertent misconfigurations that could expose networks to unauthorized access, denial-of-service attacks, or lateral movement by malicious actors.

The invention integrates real-time threat intelligence from multiple external sources to enhance its validation capabilities. It continuously ingests and processes data from cybersecurity frameworks such as MITRE ATT&CK, as well as real-time feeds from vulnerability databases, security researchers, and industry threat-sharing platforms. By correlating proposed rule changes with evolving attack techniques, the system determines whether a modification introduces new risks or mitigates existing threats. This approach ensures that security policies remain aligned with current threat landscapes, enabling organizations to proactively defend against the latest cyber threats rather than relying on reactive security measures.

A component of the invention is its dynamic risk scoring mechanism, which quantifies the potential security impact of each rule change. The system analyzes historical security incidents, previously identified vulnerabilities, and attack patterns to assign a risk score to every proposed modification. Rules that introduce significant risks, such as those that unintentionally expose sensitive resources or weaken access controls, are automatically blocked from implementation. Medium-risk changes are flagged for additional human review, while low-risk modifications are approved instantly. This prioritization mechanism enhances operational efficiency by allowing security teams to focus their attention on the most critical risks while ensuring that safe rule changes proceed without unnecessary delays.

The invention also incorporates machine learning algorithms that enable it to continuously improve its decision-making capabilities over time. By analyzing historical rule change outcomes, security incident reports, and evolving network behaviors, the system refines its risk assessment models to detect patterns indicative of security vulnerabilities. This self-learning capability ensures that the system remains adaptive and responsive to emerging threats, reducing reliance on static security policies that quickly become outdated. The AI-driven learning process also minimizes false positives and false negatives, providing more accurate risk assessments and reducing the likelihood of unnecessary rule rejections or overlooked vulnerabilities.

An important aspect of the invention is its ability to detect and prevent toxic rule combinations that could weaken overall security. A single rule change, when analyzed in isolation, may appear benign. However, when evaluated in the broader context of an entire network rule set, it may create dangerous conditions that allow unauthorized access or network segmentation failures. The system's permutation analysis proactively identifies these toxic interactions by simulating how different rule sets function together in a live environment. By detecting and preventing these conflicts before deployment, the invention ensures that security policies remain robust and that new modifications do not introduce unexpected security gaps.

The invention also provides automated feedback and real-time notifications to network administrators, ensuring that decision-making is well-informed and efficient. When a rule modification is proposed, the system generates a detailed report explaining the risks associated with the change, potential conflicts, and recommended alternatives if the modification is deemed too risky. If a high-risk rule is blocked, administrators receive a justification along with suggested mitigations to achieve the desired outcome securely. This automated reporting reduces the time required for security teams to investigate and resolve issues, streamlining the workflow for implementing necessary network changes while maintaining a high level of security.

To further enhance security teams' ability to make informed decisions, the invention includes an advanced visualization tool that provides an interactive graphical representation of network rule dependencies, risk assessments, and threat exposure levels. Traditional rule validation processes often require security administrators to manually cross-reference multiple logs, policies, and security reports to understand how different rules interact. The invention eliminates this cumbersome process by providing an intuitive interface that highlights interdependencies, visualizes risk exposure, and identifies potential areas of concern. By enabling security teams to quickly grasp the full impact of a rule change, this visualization feature enhances decision-making and reduces the likelihood of security oversights.

The invention seamlessly integrates with existing security infrastructure, including firewalls, intrusion detection systems, security information and event management (SIEM) solutions, and vulnerability scanners. This compatibility ensures that network rule validation operates within the broader security framework of an organization, utilizing real-time data from multiple security tools to enhance accuracy. The system cross-references proposed rule changes with ongoing security alerts, policy enforcement mechanisms, and regulatory compliance requirements to ensure that every modification adheres to organizational and industry standards. This integration capability enhances security cohesion across different security tools, reducing the risk of fragmented security policies.

Another key aspect of the invention is its ability to conduct simulation-based validation in a virtualized environment before applying changes to live network traffic. By leveraging a controlled simulation framework, administrators can test proposed modifications in a sandboxed environment to observe their effects on network behavior, security enforcement, and overall stability. This ensures that rule changes are thoroughly vetted before deployment, reducing the risk of unintended disruptions or security breaches. The ability to test configurations in a non-production environment provides an additional layer of security assurance, particularly for organizations with highly sensitive infrastructure, such as financial institutions and government networks.

The invention also includes an automated conflict resolution mechanism that provides intelligent recommendations for mitigating rule conflicts. If the system detects a rule change that could interfere with existing security controls, it suggests optimized configurations that achieve the same functionality without compromising security. This intelligent resolution engine eliminates the trial-and-error approach typically associated with network rule adjustments, reducing the time required to implement security-compliant changes while maintaining operational integrity. By offering pre-vetted rule alternatives, the system helps security teams resolve conflicts more efficiently and with greater confidence.

Operational efficiency is further enhanced by the automation of traditionally manual validation processes. Security administrators no longer need to spend excessive time reviewing individual rule changes, as the system automates the detection of security risks, rule conflicts, and policy violations. By reducing the workload on security teams, the invention allows organizations to implement necessary network changes more rapidly while maintaining stringent security controls. The reduction in manual labor not only increases productivity but also decreases the likelihood of human error, which is a common cause of misconfigurations and security gaps in traditional validation processes.

The adaptability of the invention ensures that it remains relevant across a variety of network architectures, including cloud, on-premises, and hybrid environments. Different network infrastructures have distinct security challenges, and the system is designed to tailor its validation approach to each unique environment. Whether an organization operates a fully cloud-based infrastructure or a hybrid model integrating legacy systems, the invention applies customized validation processes to ensure that security policies remain effective across all platforms. This contextual awareness strengthens overall security posture and enables organizations to implement best practices tailored to their specific operational needs.

The invention also enhances regulatory compliance by integrating security best practices and policy enforcement mechanisms directly into the validation process. Many industries, such as finance, are subject to strict security regulations that require organizations to document and justify changes to network configurations. The system ensures that every rule change is assessed against regulatory frameworks, industry standards, and internal security policies. By automating compliance verification, the invention reduces the risk of audit failures and regulatory consequences while ensuring that network changes align with legal and security requirements.

An additional unique feature of the invention is its ability to perform holistic impact analysis, correlating rule changes with historical security incidents, real-world attack patterns, and current vulnerabilities. This comprehensive evaluation ensures that every modification is assessed within the broader context of network security, preventing configurations that could inadvertently weaken defenses. By proactively identifying risks before they materialize, the invention enables organizations to maintain a resilient security posture while facilitating necessary network changes. Through its advanced automation, intelligence-driven analysis, and seamless integration with existing security frameworks, the invention represents a groundbreaking advancement in network rule validation and cybersecurity policy enforcement.

In light of the foregoing, the following provides a simplified summary of the present disclosure to offer a basic understanding of its various parts. This summary is not exhaustive, nor does it limit the exemplary aspects of the inventions described herein. It is not designed to identify key or critical elements or steps of the disclosure, nor to define its scope. Rather, it is intended, as understood by a person of ordinary skill in the art, to introduce some concepts of the disclosure in a simplified form as a precursor to the more detailed description that follows. The specification throughout this application contains sufficient written descriptions of the inventions, including exemplary, non-exhaustive, and non-limiting methods and processes for making and using the inventions. These descriptions are presented in full, clear, concise, and exact terms to enable skilled artisans to make and use the inventions without undue experimentation, and they delineate the best mode contemplated for carrying out the inventions.

In some arrangements, a computer-implemented method for validating network rule changes using artificial intelligence includes receiving, by a rule validation engine executed by at least one processor, a proposed network rule change to a network security configuration, wherein the proposed network rule change includes at least one modification to an existing rule set governing network access, traffic flow, or security enforcement. The method further includes generating, by a simulation engine executed by the at least one processor, a simulated ruleset by applying the proposed network rule change to an existing network security configuration stored in a rule repository, wherein the simulated ruleset is created to model the full network behavior as it would exist if the rule change were implemented in a live environment. Additionally, the method includes analyzing, by a conflict detection module executed by the at least one processor, the simulated ruleset to detect conflicts between the proposed network rule change and existing security rules, wherein detecting the conflicts comprises identifying toxic rule combinations that create security vulnerabilities by allowing unauthorized access, overriding established security controls, or weakening segmentation policies.

The method also includes retrieving, by a threat intelligence module executed by the at least one processor, real-time threat intelligence data from at least one external threat intelligence source, wherein retrieving the real-time threat intelligence data further comprises parsing structured and unstructured threat data from at least one external source selected from a group consisting of a cyber threat intelligence feed, a vulnerability database, a security information and event management (SIEM) system, a cloud security monitoring service, and a machine-readable threat intelligence standard, wherein the retrieved data provides up-to-date information on newly discovered vulnerabilities, known attack vectors, and emerging threats that may impact the proposed network rule change.

In some arrangements, the method further includes correlating, by a threat impact analysis module executed by the at least one processor, the proposed network rule change with the real-time threat intelligence data to determine whether the proposed network rule change increases exposure to known security threats, wherein correlating the proposed network rule change with the real-time threat intelligence data further comprises identifying whether the proposed network rule change aligns with at least one known attack technique, tactic, or procedure from the MITRE ATT&CK framework, ensuring that security policies remain robust against adversarial techniques documented in industry-standard security threat models.

The method also includes extracting, by a risk assessment module executed by the at least one processor, a set of risk factors from the proposed network rule change, the detected conflicts, and the correlated threat intelligence data, wherein the risk factors include, but are not limited to, the likelihood of the rule change introducing a security weakness, the sensitivity of affected network segments, and the presence of compensating security controls that may mitigate the risks associated with the rule modification. Furthermore, the method comprises computing, by an artificial intelligence model executed by the at least one processor, a risk score for the proposed network rule change based on the extracted risk factors, wherein computing the risk score further comprises applying a weighted scoring model that assigns a higher risk value to proposed network rule changes that increase susceptibility to at least one of lateral movement, unauthorized data exfiltration, denial-of-service attacks, privilege escalation, or command and control activity, wherein the AI model evaluates historical patterns of attack attempts and previously targeted vulnerabilities to generate an accurate security risk assessment.

In some arrangements, the method includes determining, by a rule decision module executed by the at least one processor, an approval status for the proposed network rule change based on the risk score, wherein determining the approval status further comprises dynamically adjusting predefined low-risk, medium-risk, and high-risk thresholds based on at least one of an organization's security policy, a predefined risk tolerance setting, or recent security incidents affecting the network, wherein changes in risk threshold levels allow the system to adapt to evolving security threats while maintaining compliance with organizational security standards. The approval status is selected from an approval status group consisting of automatic approval of the proposed network rule change when the risk score is below the predefined low-risk threshold, automatic rejection of the proposed network rule change when the risk score exceeds the predefined high-risk threshold, and flagging the proposed network rule change for manual review when the risk score falls within the predefined medium-risk range, wherein flagged rule changes require administrator intervention to evaluate security concerns prior to implementation.

In some arrangements, the method also includes simulating, by a virtualized environment module executed by the at least one processor, a deployment of the proposed network rule change in a virtualized test environment when the proposed network rule change is flagged for manual review, wherein simulating the deployment further comprises generating synthetic network traffic to model real-world usage scenarios and identifying whether the proposed network rule change introduces latency, packet loss, or unintended traffic redirection, wherein the simulation allows security teams to test how a rule change affects overall network performance and security without impacting live production traffic. The method includes presenting, by a visualization module executed by the at least one processor, a graphical representation of the proposed network rule change, the detected conflicts, and the computed risk score, wherein presenting the graphical representation further comprises overlaying real-time network traffic patterns, security alerts, and historical rule change data to provide contextual insights into how the proposed network rule change interacts with existing network conditions, allowing administrators to visually assess security risks and potential policy violations.

In some arrangements, the method includes generating, by a feedback module executed by the at least one processor, an automated report describing the security implications of the proposed network rule change, wherein generating the automated report further comprises including a confidence level score indicating the reliability of the risk assessment, wherein the confidence level score is derived from an uncertainty analysis of historical artificial intelligence model predictions, recent changes in threat intelligence data, and variance in detected security incidents, providing a quantitative measure of the model's confidence in its decision-making process. The method also includes transmitting, by a notification module executed by the at least one processor, the automated report to at least one security administrator for further review when the proposed network rule change is flagged for manual review or rejected, wherein the report provides administrators with actionable insights into why a rule was rejected or flagged and suggests alternative rule modifications.

In some arrangements, the method includes implementing, by a rule enforcement module executed by the at least one processor, the proposed network rule change in the network security configuration when the proposed network rule change is automatically approved or manually approved following a review by the at least one security administrator, ensuring that approved rule modifications are deployed efficiently. The method further includes logging, by an audit module executed by the at least one processor, the implemented network rule change along with the associated risk score, approval status, and any detected conflicts for compliance tracking and forensic analysis, wherein logging the implemented network rule change further comprises generating a digitally signed cryptographic record of the rule change, the risk score, and the approval status to ensure integrity, authenticity, and non-repudiation of security policy modifications, allowing for future audits and security reviews.

In some arrangements, the method includes continuously training, by a machine learning module executed by the at least one processor, the artificial intelligence model using historical rule change data, detected security incidents, and evolving threat intelligence to refine future risk assessments and rule validation decisions, wherein the AI model continuously adapts to new security threats and improves its predictive accuracy over time.

The method also includes updating, by a self-adaptive security module executed by the at least one processor, network security policies dynamically based on newly identified threats, security vulnerabilities, and changes in regulatory compliance requirements, wherein updating the network security policies dynamically further comprises automatically generating at least one compensating security control in response to an identified high-risk rule change, wherein the compensating security control is selected from a group consisting of a temporary firewall rule adjustment, an adaptive access control modification, a security monitoring rule enhancement, and a privileged user access restriction, ensuring that potential security gaps introduced by rule changes are proactively mitigated.

By implementing these arrangements, the method provides an intelligent, automated framework for validating network rule changes, ensuring that security configurations remain robust against evolving cyber threats while minimizing human errors and operational risks. The integration of artificial intelligence, threat intelligence, machine learning, and automated simulations enhances decision-making capabilities and enables organizations to maintain a secure, adaptive, and efficient network infrastructure.

The following description and claims, in conjunction with the drawings-all integral parts of this specification-will clarify various features and characteristics of the current technology. Like reference numerals in the figures correspond to similar parts, enhancing understanding of the technology's methods of operation and the functions of related structural elements, as well as the synergies and economies of their combinations. Some of the processes or procedures described here may be implemented, in whole or in part, as computer-executable instructions recorded on computer-readable media, configured as computer modules, or in other computer constructs. These steps and functionalities may be executed on a single device or distributed across multiple devices interconnected with one another. However, it is important to acknowledge that the drawings primarily serve for descriptive and illustrative purposes and are not intended to delineate the limits of the invention. Unless contextually evident, the singular forms of “a,” “an,” and “the” used throughout the specification and claims should be interpreted to include their plural counterparts.

### BRIEF DESCRIPTION OF DRAWINGS

FIG. 1 is an exemplary system architecture diagram in accordance with one or more embodiments disclosed herein that illustrates an artificial intelligence-driven network rule validation system designed to assess, simulate, and enforce network security policy changes while mitigating risks through real-time threat intelligence, conflict detection, and machine learning-based risk assessment. The diagram depicts interconnected components including a rule validation engine, simulation engine, conflict detection module, artificial intelligence model, threat intelligence module, virtualized testing environment, feedback and visualization modules, and enforcement mechanisms that collectively ensure the security, compliance, and operational integrity of network rule modifications.

FIG. 2 is an exemplary flow diagram in accordance with one or more embodiments disclosed herein that illustrates an artificial intelligence-driven process for validating network rule changes by analyzing conflicts, assessing security risks, correlating real-time threat intelligence, and determining rule approval status through automated and manual review mechanisms. The flow diagram depicts the sequential steps of receiving a proposed rule change, simulating its impact, computing a risk score, performing virtualized testing, generating a security impact report, and dynamically adapting security policies to maintain a resilient and compliant network security posture.

FIGS. 3A-3D collectively illustrate an exemplary sequence diagram in accordance with one or more embodiments disclosed herein that shows the interactions between system components and actors involved in the validation of network rule changes using artificial intelligence, real-time threat intelligence, and automated risk assessment. The sequence diagrams details the end-to-end process of receiving a proposed rule change, simulating its impact, detecting conflicts, correlating security risks, performing virtualized testing, generating security impact reports, and ultimately determining whether the rule change is approved, rejected, or requires manual review before enforcement.

FIG. 4 is an exemplary class diagram in accordance with one or more embodiments disclosed herein that illustrates the object-oriented architecture of an artificial intelligence-driven network rule validation system, detailing its key components, attributes, and methods. The diagram represents the interactions between core classes, including the rule validation engine, simulation engine, conflict detection module, threat intelligence module, artificial intelligence model, rule decision module, virtualized environment module, rule enforcement module, audit module, self-adaptive security module, and machine learning module, to ensure secure and intelligent rule validation, risk assessment, and enforcement.

### DETAILED DESCRIPTION

The invention is a comprehensive, artificial intelligence-driven system designed to validate, analyze, and enforce network rule changes while mitigating security risks, preventing misconfigurations, and ensuring compliance with evolving security policies. The system leverages a combination of machine learning, real-time threat intelligence, simulation-based testing, and automated risk assessment to evaluate the security impact of proposed rule modifications before implementation. By integrating multiple layers of analysis, including conflict detection, risk scoring, and virtualized simulation, the system enhances the security and reliability of network rule enforcement.

The system begins by receiving a proposed network rule change from either a network administrator or an automated security policy management system. The proposed rule change includes details such as source and destination IP addresses, protocol specifications, access control parameters, and security enforcement policies. Upon receipt, the rule validation engine processes the request by ensuring that the rule follows a predefined format, contains all necessary attributes, and does not violate structural integrity requirements. If any required elements are missing or improperly defined, the system immediately rejects the rule change and notifies the requestor of the issue.

Once validated for format and structure, the proposed rule change is stored in a centralized rule repository, which maintains a historical record of all rule modifications for compliance tracking and audit purposes. The rule repository enables the system to enforce version control, track changes over time, and retrieve previous rule configurations when necessary. The system then forwards the proposed rule change to the simulation engine, which generates a simulated ruleset by integrating the new rule with the existing network security configuration. This simulation allows the system to model real-world conditions and evaluate how the rule interacts with pre-existing security policies.

The simulated ruleset is then sent to the conflict detection module, which analyzes the rule for potential conflicts, toxic rule combinations, and misconfigurations. Toxic rule combinations arise when a new rule inadvertently overrides or weakens existing security mechanisms, allowing unauthorized access or creating unintended access pathways. The conflict detection module ensures that the rule does not introduce contradictions or vulnerabilities that could compromise the security posture of the network. If a conflict is detected, the system logs the issue and proceeds to assess its severity and potential impact.

To further refine the security analysis, the system retrieves real-time threat intelligence from external sources such as cybersecurity threat feeds, vulnerability databases, SIEM platforms, and cloud security monitoring services. The threat intelligence module processes this data to determine whether the proposed rule change increases exposure to known attack vectors, targets, or adversarial techniques. By correlating the rule change with current threat intelligence, the system ensures that security policies remain aligned with the latest developments in cybersecurity and regulatory compliance.

The threat intelligence findings are then forwarded to the risk assessment module, which extracts key risk factors associated with the proposed rule modification. These factors include access control deviations, potential privilege escalation, exposure to critical network segments, and the likelihood of attack. The extracted risk factors are then sent to the artificial intelligence model, which applies machine learning algorithms to compute a comprehensive risk score for the proposed rule change. This risk score quantifies the likelihood of the rule introducing security vulnerabilities and provides a structured approach to risk evaluation.

The rule decision module receives the computed risk score and determines whether the rule should be automatically approved, rejected, or flagged for manual review. If the risk score falls below a predefined low-risk threshold, the system automatically approves the rule and enforces it within the live security configuration. If the risk score exceeds a high-risk threshold, the system automatically rejects the rule, logs the decision, and notifies the requestor with an explanation of the rejection. If the rule falls within a medium-risk range, the system flags it for manual review by a security administrator.

For rule changes requiring manual review, the system initiates a virtualized test environment to simulate the impact of the rule change under controlled conditions. The virtualized environment module generates synthetic network traffic to assess the operational and security effects of the rule modification. This simulation allows security teams to evaluate the rule in real-world scenarios, monitoring for unintended traffic disruptions, latency issues, security gaps, or conflicts with existing enforcement mechanisms. The results of the simulation provide additional insight into the rule's viability.

Following the simulation, the system generates a security impact report summarizing the findings from the risk assessment, threat intelligence correlation, and virtualized testing. The feedback module compiles these insights into a structured report that includes detected conflicts, identified vulnerabilities, recommended mitigations, and a confidence level score that quantifies the reliability of the risk assessment. This report is then presented to the security administrator, who is responsible for reviewing the flagged rule change and making a final determination regarding its approval or rejection.

If the security administrator approves the rule change based on the security impact report, the system forwards the rule to the rule enforcement module, which applies the validated modification to the live network security configuration. The rule enforcement module ensures that the change is implemented correctly and adheres to predefined security policies. Once applied, the system logs the rule change in the audit repository for compliance tracking and forensic analysis. If the security administrator rejects the rule, the decision is recorded in the audit log, and the requestor is notified with an explanation of why the rule was not approved.

The system continuously learns from historical rule validation decisions and security incidents by leveraging a machine learning module that refines the artificial intelligence model over time. The machine learning module trains the AI model using past rule validation outcomes, detected vulnerabilities, and evolving threat intelligence to improve future risk assessments. This ensures that the system becomes more accurate and adaptive in predicting security risks, minimizing the likelihood of approving high-risk rule changes.

Additionally, the system incorporates a self-adaptive security module that dynamically updates network security policies in response to newly identified threats and evolving compliance requirements. If a high-risk rule change is detected, the self-adaptive security module can automatically apply compensating security controls such as temporary firewall rule adjustments, access control restrictions, or enhanced security monitoring to mitigate potential risks. This proactive approach ensures that network security policies remain responsive to emerging threats without requiring manual intervention.

The system is designed to provide a structured, scalable, and automated approach to network rule validation, reducing the reliance on manual rule enforcement while improving security decision-making. By integrating AI-driven risk analysis, real-time threat intelligence, and automated conflict detection, the system minimizes the potential for human error, enforces consistent security policies, and enhances network resilience against cyber threats. The use of a centralized rule repository and audit module ensures that all rule validation decisions are recorded for compliance tracking and forensic investigation.

Through its advanced risk evaluation capabilities, the system optimizes the process of network rule validation by filtering out high-risk modifications while ensuring that legitimate rule changes are deployed efficiently. The incorporation of visualized security impact reports provides administrators with clear insights into the risks and benefits associated with each proposed rule change, allowing for informed decision-making. The ability to simulate rule changes in a virtualized environment further enhances security by enabling proactive risk assessment before deployment.

The system's continuous learning capabilities enable it to evolve alongside emerging cybersecurity threats, refining its predictive accuracy through machine learning-based training. This ensures that security teams can adapt to new attack methodologies and regulatory requirements without requiring constant manual adjustments. The integration of self-adaptive security policies further enhances network resilience by automatically enforcing security updates in response to detected vulnerabilities.

The invention provides an end-to-end solution for validating network rule changes, ensuring that each modification undergoes thorough security analysis, conflict detection, AI-driven risk assessment, and real-world simulation before enforcement. By combining artificial intelligence, automation, and human oversight, the system enhances network security, reduces misconfigurations, and maintains compliance with organizational security policies. The combination of automated risk scoring, real-time threat correlation, and proactive security policy adaptation enables organizations to secure their networks efficiently while minimizing operational disruptions.

The description of various example embodiments herein is intended to achieve the goals previously outlined, referencing the illustrations included in this disclosure. These illustrations depict multiple systems and methods for implementing the disclosed information. It should be recognized that alternative implementations are possible, and modifications to both structure and functionality may be made. The description details various connections between elements, which should be interpreted broadly. Unless explicitly stated otherwise, these connections can be either direct or indirect and may be established through either wired or wireless methods. This document does not aim to restrict the nature of these connections.

In various configurations, terms such as “computers” and “machines” refer to devices that may be general-purpose or specialized for specific tasks, whether physical or virtual, and capable of network connectivity. These devices encompass all necessary hardware, software, and components known to skilled practitioners, including application-specific integrated circuits (ASICs), microprocessors, cores, or other processing units. These components execute, control, or implement various types of software, instructions, data, modules, processes, or routines. The terms used do not restrict the device type and should be broadly interpreted. Software, data, and executable code can reside on various physical, computer-readable storage devices, such as local memory, cloud-based storage, or network-attached storage. These can be stored in both volatile and non-volatile memory and may function autonomously or respond to specific triggers. These elements can be consolidated or distributed across multiple devices and stored in accessible memory systems such as distributed databases, big data infrastructures, blockchains, or distributed ledgers.

Networks and similar references refer to a broad range of communication systems, from local area networks (LANs) and wide area networks (WANs) to the Internet and cloud-based networks, supporting wired and wireless configurations. Specialized networks like digital subscriber line (DSL), frame relay, asynchronous transfer mode (ATM), and virtual private networks (VPN) are included. These networks utilize various hardware and software components, including modems, routers, firewalls, switches, and adapters, to facilitate communication. Networks are also equipped with virtual IP addresses and support multiple protocols like HTTPS, enabling effective packet-based data transmission and communication.

Generative Artificial Intelligence (AI) refers to AI techniques that learn from training data and generate new content, such as text, code, images, and audio. Generative AI systems, often powered by large language models (LLMs) like GPT-3, GPT-4, Meta LLaMA, and others, can be deployed through APIs, search engines, or chatbots. These models, which may be proprietary or open source, leverage deep learning methods and are generally governed by enterprise policies regarding AI and risk. Models such as BERT, T5, AlphaFold, Watson, Megatron, and others play a role in generating or interpreting language and content for various applications.

Generative AI and LLMs are utilized throughout this disclosure for tasks including natural language processing, data analysis, real-time processing, software development, and creative content generation. Specific functions include trend analysis, data classification, sentiment analysis, writing assistance, language translation, and decision-making support. These models enable capabilities like feedback learning, context determination, and comprehensive search operations, improving performance through iterative learning and feedback from human or system interactions. The wide range of applications supported by generative AI makes these systems a powerful tool in generating, analyzing, and managing information across diverse fields. All configurations and uses of these models are within the scope of this disclosure.

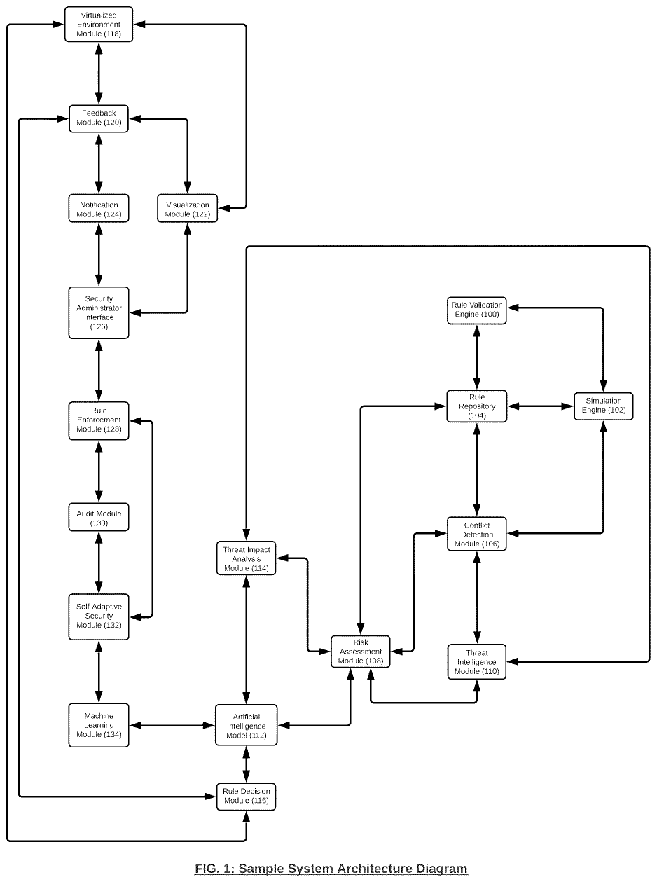

FIG. 1 illustrates a comprehensive system architecture designed for validating network rule changes using artificial intelligence, ensuring that security policies remain adaptive, resilient, and aligned with evolving cyber threats. The system architecture consists of multiple interconnected components, each of which performs a distinct yet collaborative function in evaluating, analyzing, simulating, and enforcing network rule modifications. Each module in the system architecture plays a vital role in determining the security impact of a proposed rule change and making intelligent, automated decisions to either approve, reject, or flag the rule change for further review. The architecture ensures that all modifications are thoroughly assessed before implementation, reducing the risk of misconfigurations, security breaches, and unintended network disruptions.

The system begins with the Rule Validation Engine (100), which acts as the central processing unit for receiving a proposed network rule change. This proposed change may be introduced by a network administrator manually configuring firewall rules, a security automation system enforcing compliance updates, or a third-party security service integrating with the organization's security framework. The rule validation engine (100) is responsible for parsing and analyzing the received rule change request, extracting relevant metadata such as source and destination addresses, access control parameters, protocol specifications, and port configurations. The rule validation engine (100) ensures that all required attributes are included in the rule change request before forwarding it for further processing.

Upon receiving the proposed rule change, the rule validation engine (100) initiates the validation process by forwarding the rule modification to the Simulation Engine (102). The simulation engine (102) plays a critical role in preemptively assessing the impact of the proposed rule before it is applied to the live network. By leveraging an advanced modeling framework, the simulation engine (102) generates a Simulated Ruleset (103) that incorporates the proposed modification within the broader context of the existing network security configuration. The purpose of this simulation is to model real-world conditions and evaluate how the new rule will behave in practice, ensuring that it does not inadvertently override security mechanisms or introduce vulnerabilities. The simulated ruleset (103) is used for further security analysis, including conflict detection, risk assessment, and impact prediction.

To accurately simulate network behavior, the simulation engine (102) retrieves historical and active rule configurations from the Rule Repository (104), which serves as the centralized database for storing security policies, firewall configurations, access control lists, and prior rule modifications. The rule repository (104) maintains an organized record of network policies, ensuring that the simulation engine (102) has access to all relevant data necessary for rule validation. The repository (104) also includes version control functionality, enabling administrators to track changes made to rule configurations over time. This allows for rollback functionality in cases where a new rule change introduces unintended negative consequences. The repository (104) supports structured queries to retrieve specific rule configurations based on attributes such as rule priority, traffic type, network segment, and enforcement status.

After generating the simulated ruleset (103), the Conflict Detection Module (106) analyzes the proposed rule change to detect potential conflicts. The conflict detection module (106) is responsible for identifying rule contradictions, misconfigurations, or Toxic Rule Combinations (107) that may create security vulnerabilities. Toxic rule combinations occur when two or more rules, when applied together, weaken the overall security posture, such as allowing unauthorized traffic flow or overriding an established access control policy. The conflict detection module (106) ensures that such conflicts are identified before implementation, preventing security gaps that could be targeted by malicious actors. Additionally, the conflict detection module (106) compares the proposed rule change against Historical Rule Violations (109) stored in the rule repository (104) to identify patterns of misconfigurations that have previously resulted in security breaches or policy violations.

The Risk Assessment Module (108) plays a crucial role in evaluating the security implications of the proposed rule change. This module (108) takes input from both the conflict detection module (106) and the Threat Intelligence Module (110) to assess the overall risk associated with the rule modification. The threat intelligence module (110) continuously retrieves and processes real-time threat data from external security sources, including cyber threat intelligence feeds, vulnerability databases, security information and event management (SIEM) platforms, cloud security monitoring services, and structured machine-readable threat intelligence standards. The threat intelligence module (110) prioritizes external intelligence sources based on credibility, relevance, and timeliness, ensuring that the most up-to-date security information is considered in the rule validation process.

Once the threat intelligence module (110) retrieves and processes security data, the Threat Impact Analysis Module (114) takes this information and correlates it with the proposed rule change. This module (114) determines whether the rule modification increases exposure to known threats and attack techniques, such as those documented in the MITRE ATT&CK framework. By cross-referencing rule changes with known adversarial tactics, the system can predict whether the modification aligns with documented attack methodologies and may potentially increase the risk of lateral movement, privilege escalation, unauthorized data exfiltration, denial-of-service attacks, or command and control operations. The results from the threat impact analysis module (114) are then fed into the Artificial Intelligence Model (112), which performs an in-depth security risk assessment.

The artificial intelligence model (112) utilizes advanced machine learning techniques to compute a Risk Score (113) for the proposed network rule change. The AI model (112) applies a weighted scoring algorithm that considers various factors, such as the likelihood of attack, the impact of the rule modification on critical network segments, and historical security incidents related to similar rule changes. The AI model (112) continuously refines its predictive accuracy by training on past rule change data, security incidents, and evolving threat intelligence. The risk score (113) generated by the artificial intelligence model (112) provides a quantitative representation of the security risk associated with the rule change, enabling the system to make data-driven decisions.

Based on the computed risk score (113), the Rule Decision Module (116) determines the final approval status of the proposed rule change. This module (116) categorizes rule modifications into three distinct approval statuses: automatic approval for rule changes classified as low risk, automatic rejection for rule changes classified as high risk, and Flagged for Manual Review (117) when the risk score falls within a medium-risk threshold. The rule decision module (116) dynamically adjusts these predefined risk thresholds based on organizational security policies, predefined risk tolerance settings, and recent security incidents that may impact the overall security posture. By implementing dynamic risk thresholds, the system ensures that rule modifications align with the organization's evolving security requirements.

For rule changes flagged for manual review (117), the Virtualized Environment Module (118) performs a detailed simulation of the proposed modification within a controlled test environment. This module (118) generates Synthetic Network Traffic (119) to model real-world usage scenarios and analyze whether the rule modification introduces latency, packet loss, unintended traffic redirection, or other performance disruptions. The purpose of this virtualized simulation is to assess the operational and security impact of the rule change before deployment, providing security teams with critical insights into its effects.

Following the simulation, the Feedback Module (120) generates an automated Security Impact Report (121) summarizing the security implications of the proposed rule change. The report includes a justification for the approval status, an explanation of detected conflicts, a summary of correlated threat intelligence data, and a list of recommended mitigations for addressing security risks. The report also includes a Confidence Level Score (123) that indicates the reliability of the risk assessment, which is derived from an uncertainty analysis of historical AI model predictions, recent changes in threat intelligence, and variance in detected security incidents.

The Visualization Module (122) presents a graphical representation of the proposed rule change, overlaying security risk indicators, historical rule change data, and real-time network traffic patterns. The Notification Module (124) alerts security administrators when a rule change has been flagged for review or rejected. If a flagged rule change is manually approved, the Rule Enforcement Module (128) ensures that the validated modification is correctly applied to the live network security configuration.

The Audit Module (130) logs each implemented modification along with its associated risk score, approval status, and security impact assessment. The Self-Adaptive Security Module (132) dynamically updates network security policies based on newly identified threats. The Machine Learning Module (134) continuously trains the AI model (112) using security incident data, ensuring evolving cyber threats are addressed dynamically.

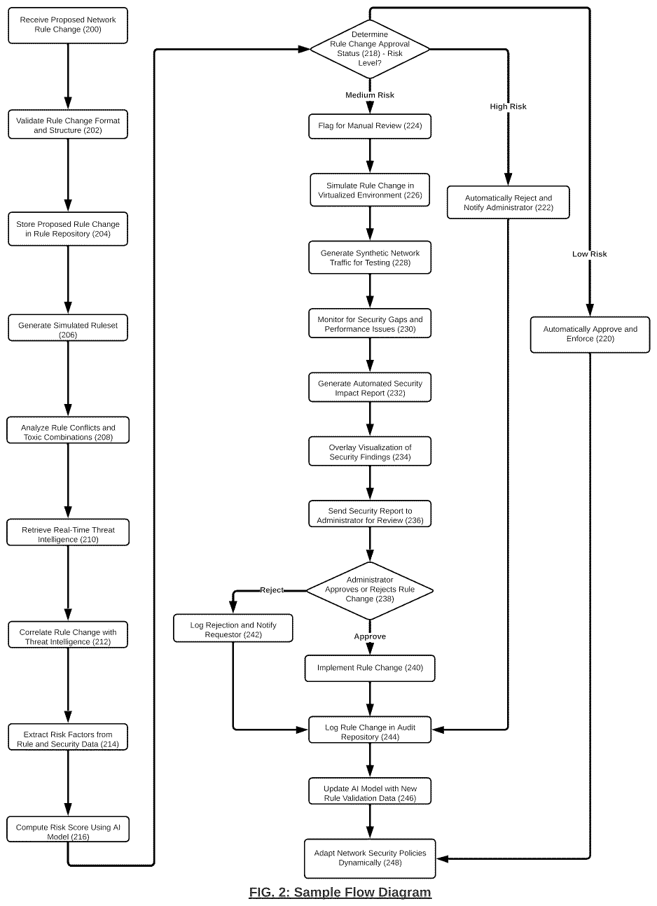

FIG. 2 is an exemplary flow diagram that illustrates the detailed process for validating network rule changes using artificial intelligence. The flow diagram represents a structured sequence of operations, beginning with the receipt of a proposed network rule change and progressing through validation, conflict detection, risk assessment, real-time threat intelligence correlation, and enforcement or rejection of the rule modification. The system ensures that all network security policy modifications undergo rigorous evaluation before implementation, leveraging artificial intelligence, machine learning, external threat intelligence, and virtualized simulations to prevent misconfigurations and security vulnerabilities.

The process begins when the system receives a proposed network rule change submitted by a network administrator, an automated security policy management system, or an external security service (200). The rule change typically consists of modifications to network access control lists, firewall rules, security group configurations, or other security enforcement mechanisms. The system then validates the format and structure of the proposed rule change (202), ensuring that it adheres to predefined syntax and completeness requirements. If the rule lacks necessary parameters, such as source and destination IP addresses, port numbers, or protocol details, it is rejected immediately, and an error notification is sent to the requestor.

Once the rule format is validated, the system stores the proposed rule change in a centralized rule repository (204). The rule repository maintains a structured database of all historical and active security policies, allowing administrators to track changes, enforce version control, and audit modifications for compliance purposes. The proposed rule change is then retrieved from the rule repository, and a simulated ruleset is generated (206). The simulated ruleset models how the rule will behave within the current security configuration, allowing the system to evaluate its impact before deployment.

The system proceeds to analyze the simulated ruleset for conflicts, misconfigurations, and toxic rule combinations (208). The conflict detection module ensures that the proposed rule does not override existing security controls, introduce unintended access permissions, or create contradictory rules that could weaken the network's overall security posture. This analysis includes identifying toxic rule combinations, which occur when multiple rules interact in a way that inadvertently permits unauthorized access or disrupts security enforcement mechanisms.

To further enhance security evaluation, the system retrieves real-time threat intelligence from external sources (210). The threat intelligence module continuously ingests and processes security data from various feeds, including cyber threat intelligence platforms, vulnerability databases, SIEM systems, cloud security monitoring services, and structured machine-readable intelligence sources. This ensures that rule validations account for the latest emerging threats and vulnerabilities. The system then correlates the proposed rule change with the retrieved threat intelligence data (212) to determine whether the rule modification introduces exposure to known attack tactics, adversary methodologies, or actively targeted vulnerabilities.

Following threat intelligence correlation, the system extracts key risk factors associated with the proposed rule change (214). These risk factors may include the sensitivity of the affected network segment, the level of access granted by the rule, the potential for privilege escalation, and the likelihood of the rule being targeted in a real-world attack scenario. The artificial intelligence model then processes these risk factors and computes a comprehensive risk score for the proposed rule change (216). The AI model applies a weighted scoring algorithm that evaluates multiple risk dimensions, leveraging historical security incidents, past misconfigurations, and emerging threat intelligence data.

The system then determines the approval status of the proposed network rule change based on the computed risk score (218). If the risk score falls below a predefined low-risk threshold, the rule is automatically approved and enforced in the live security configuration (220). If the risk score exceeds a predefined high-risk threshold, the system automatically rejects the rule modification, logs the rejection event, and sends a notification to the administrator explaining the security concerns (222). If the risk score falls within a medium-risk threshold, the system flags the rule change for manual review by a security administrator (224), requiring additional evaluation before implementation.

For rule changes flagged for manual review, the system initiates a virtualized simulation to test the rule's impact in a controlled environment (226). A virtualized test environment is created, replicating real-world network conditions to model how the rule change will affect traffic flow, security enforcement, and performance. The system generates synthetic network traffic (228) within the test environment to analyze the rule's behavior under different conditions, ensuring that potential disruptions or security gaps are identified before deployment. The system continuously monitors the simulation for security gaps, traffic anomalies, and performance degradation (230), allowing security analysts to assess whether the rule change introduces any unintended vulnerabilities.

After completing the virtualized simulation, the system generates an automated security impact report (232). This report provides a comprehensive analysis of the rule change, including risk assessment findings, detected conflicts, correlated threat intelligence data, and suggested mitigation strategies. The system overlays a visual representation of the security findings (234), allowing security administrators to review risk factors, rule dependencies, and affected network segments in an interactive format. The security impact report is then transmitted to the administrator for review (236), enabling human decision-making for flagged rule modifications.

The security administrator then reviews the security impact report and decides whether to approve or reject the rule change (238). If the administrator determines that the rule modification meets security requirements and does not introduce unacceptable risks, the rule is approved and enforced in the live network configuration (240). If the administrator identifies security concerns that cannot be mitigated, the rule change is rejected, and the decision is logged in the audit repository (242). The system notifies the requestor of the rejection, providing detailed feedback on why the modification was not approved.

Regardless of whether the rule change is approved or rejected, the system logs the final decision and associated risk assessment in the audit repository (244). The audit module ensures that all rule validation decisions are recorded for compliance tracking, forensic analysis, and regulatory reporting. The system then updates the AI model with new validation data (246), incorporating insights from the latest rule changes, security incidents, and risk assessments to improve future decision-making accuracy. Finally, the system dynamically adapts network security policies (248), adjusting configurations based on newly identified threats, evolving security requirements, and compliance mandates.

Thus, FIG. 2 represents a structured, automated approach to network rule validation, leveraging artificial intelligence, threat intelligence, and simulation-based analysis to ensure that security policies remain effective and resilient against emerging threats. The system minimizes manual effort by automating conflict detection, risk assessment, and rule enforcement while providing administrators with detailed reports, real-time visualizations, and adaptive security controls. By integrating AI-driven decision-making and real-time security intelligence, the system enhances an organization's ability to manage network security configurations efficiently, reducing the risk of misconfigurations, unauthorized access, and operational disruptions.

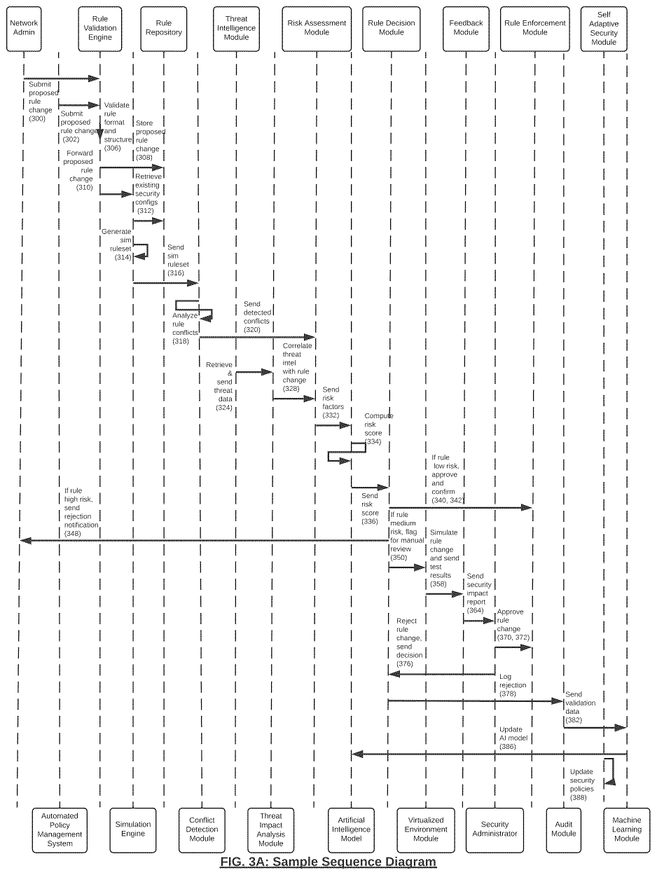

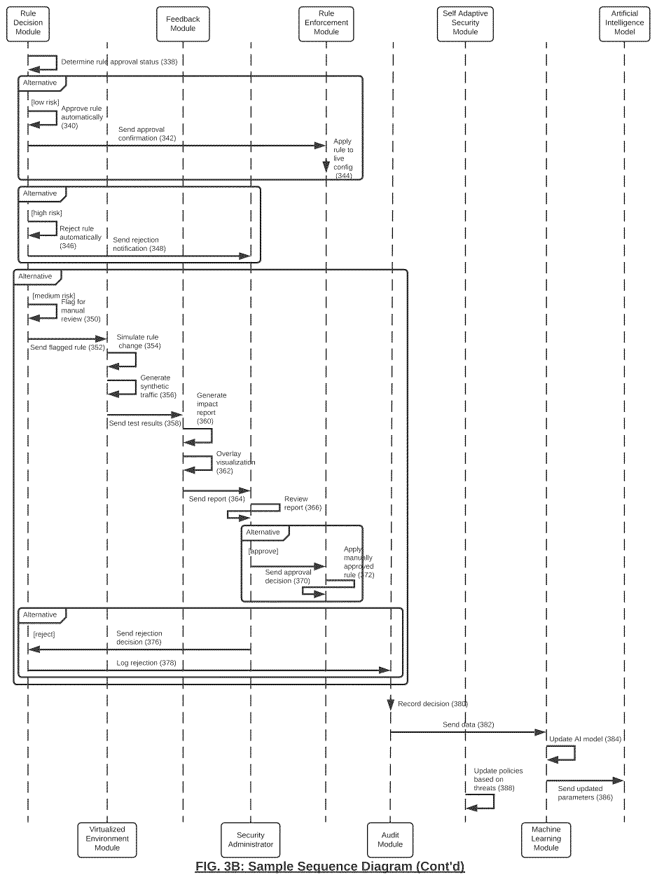

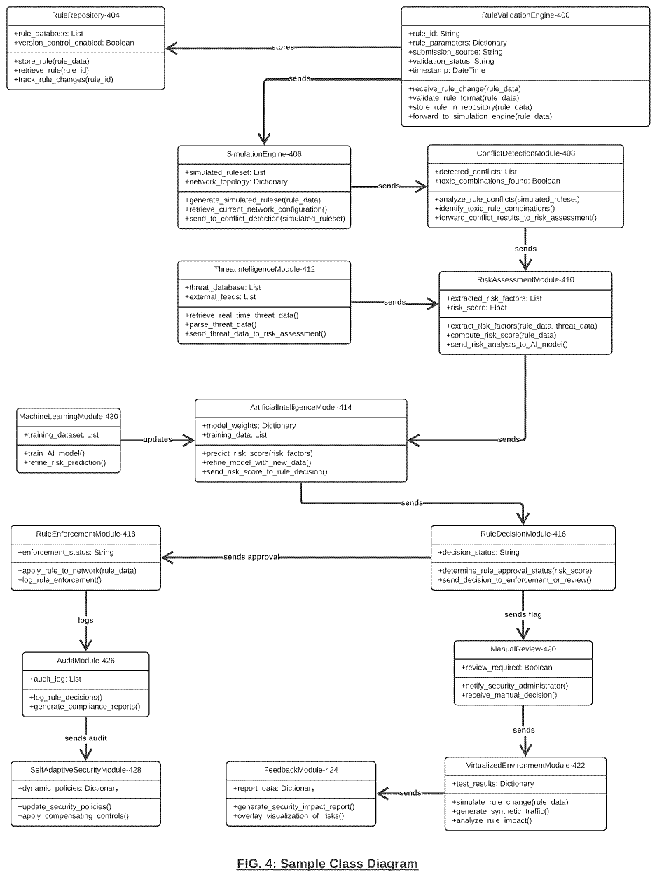

FIGS. 3A-3D collectively are an exemplary sequence diagram illustrating the interactions between various actors and system components involved in validating network rule changes using artificial intelligence.

The sequence diagram initially illustrates the interactions between key system components and actors involved in the validation and risk assessment of network rule changes. This diagram focuses on the initial receipt, validation, simulation, conflict detection, risk assessment, and AI-driven decision-making processes before determining whether a rule should be approved, rejected, or flagged for review.

The sequence diagram next illustrates the interactions that occur after the risk assessment is completed. This diagram focuses on determining the rule's approval status, performing virtualized testing if required, enforcing approved rules, rejecting high-risk rules, logging audit records, and updating security policies dynamically.

The sequence begins with the Network Administrator submitting a proposed network rule change for approval (300). This rule change includes parameters such as source and destination IP addresses, protocol specifications, port numbers, and access control permissions. The rule change may also be generated automatically by the Automated Policy Management System, which enforces predefined security policies and compliance mandates by proposing new or updated rule configurations based on changing network requirements (302). The Rule Validation Engine receives the proposed network rule change (304) and is responsible for processing and validating it. This engine first verifies whether the rule is formatted correctly and contains all required attributes (306). If the rule is incomplete, improperly structured, or missing critical security parameters, the rule validation engine rejects the request and notifies the requestor with an explanation.

Once the format and structure of the proposed rule change are validated, the system stores the rule in the Rule Repository (308). The rule repository maintains a centralized record of all network security rules, including historical modifications, version control metadata, and compliance tracking data. The Rule Validation Engine then forwards the rule change to the Simulation Engine (310), which is responsible for modeling how the new rule will behave when integrated into the existing security policy framework. The simulation engine retrieves the latest network security configurations from the Rule Repository to ensure that the simulated environment accurately represents the current state of the network (312). The simulation engine then generates a Simulated Ruleset incorporating the proposed rule change (314). This simulated ruleset is then sent to the Conflict Detection Module for evaluation (316).

The Conflict Detection Module analyzes the proposed rule change to identify security policy conflicts, misconfigurations, and toxic rule combinations (318). Toxic rule combinations occur when the introduction of a new rule unintentionally creates conditions that weaken the network's security posture, such as allowing unauthorized access, overriding established security policies, or creating unintended access pathways. If conflicts are detected, they are logged and sent to the Risk Assessment Module for further evaluation (320). While the conflict detection analysis is being conducted, the Threat Intelligence Module retrieves real-time security threat intelligence from external sources (322). These sources include vulnerability databases, SIEM platforms, cyber threat intelligence feeds, and cloud security monitoring services. The Threat Intelligence Module processes and filters the retrieved intelligence data to prioritize security alerts based on severity and relevance to the network (324).

The Threat Impact Analysis Module receives the processed threat intelligence and correlates it with the proposed rule change (326). This correlation process determines whether the rule modification increases exposure to known attack vectors, targets, or adversary tactics. If the rule change introduces a security weakness linked to an active target or a known attacker methodology, it is flagged as high risk. The results of this correlation analysis are then sent to the Risk Assessment Module (328). The Risk Assessment Module extracts key risk factors associated with the rule change, including access control deviations, potential security vulnerabilities, and operational impact (330). These extracted risk factors are then sent to the Artificial Intelligence Model, which is responsible for computing a comprehensive risk score for the rule change (332).

The Artificial Intelligence Model utilizes historical attack patterns, previous rule validation outcomes, and real-time security threat intelligence to compute a Risk Score (334). The risk score quantifies the probability of the rule change introducing security risks, enabling the system to make informed decisions regarding rule approval or rejection. The computed risk score is sent to the Rule Decision Module (336), which determines whether the rule should be automatically approved, rejected, or flagged for manual review (338). If the rule change is classified as low risk based on the predefined risk thresholds, it is automatically approved and forwarded to the Rule Enforcement Module for implementation (340). The Rule Enforcement Module applies the approved rule change to the live network security configuration (342), ensuring that it takes effect immediately (344).

If the risk score is classified as high, the Rule Decision Module automatically rejects the rule change (346). A rejection notification is then sent to the Network Administrator, detailing the reasons for rejection and suggested corrective actions (348). If the rule change falls within a medium-risk range, it is flagged for Manual Review by a Security Administrator (350). Flagged rule changes require additional human oversight to evaluate potential security risks. Before an administrator makes a final decision, the system forwards the flagged rule change to the Virtualized Environment Module for testing (352).

The Virtualized Environment Module simulates the rule change in a controlled test environment (354). This module creates an isolated virtual network where the rule change can be tested without impacting production traffic. To evaluate real-world security implications, the Virtualized Environment Module generates Synthetic Network Traffic (356) that mimics real-world usage scenarios, including normal network activity and potential attack simulations. The system monitors the test environment for security gaps, traffic anomalies, and performance degradation (358). These test results are then sent to the Feedback Module, which generates an Automated Security Impact Report (360).

The Feedback Module overlays a Visualization of Security Findings (362), providing administrators with an interactive graphical representation of the rule change's security implications, including identified risks, affected network segments, and potential mitigation strategies. The Feedback Module then sends the security impact report to the Security Administrator for further review (364). The Security Administrator examines the report and manually determines whether the rule should be approved or rejected (366). If the administrator approves the rule change, it is sent to the Rule Enforcement Module for final implementation in the live network configuration (368). The Rule Enforcement Module applies the manually approved rule, ensuring that it aligns with existing security policies and compliance requirements (370).

If the Security Administrator rejects the rule change, the rejection decision is logged in the Audit Module (374). The Rule Decision Module records the rejection decision, and a notification is sent to the requestor explaining why the rule was not approved (376). The Audit Module ensures that all rule validation decisions, including approvals and rejections, are securely logged for compliance tracking and forensic analysis (378). The recorded validation data is then sent to the Machine Learning Module, which continuously updates the artificial intelligence model using the latest security insights (380). The Machine Learning Module trains the AI model based on past validation decisions, refining its predictive accuracy and risk assessment capabilities (382).

The Self Adaptive Security Module dynamically updates network security policies based on emerging threats, ensuring that future rule validations align with evolving security landscapes (384). If new vulnerabilities or attack methodologies are detected, the self-adaptive security module can proactively modify security policies to prevent attack (386). This continuous adaptation process ensures that the system remains resilient against evolving cyber threats while maintaining an optimal security posture.

Thus, the sequence diagram is a highly structured and automated process for validating network rule changes, integrating artificial intelligence, real-time threat intelligence, virtualized testing, and human oversight to ensure the security and compliance of all modifications. The sequence diagram demonstrates how proposed rule changes undergo multiple layers of evaluation, including conflict detection, AI-driven risk assessment, threat intelligence correlation, and administrator review before final enforcement. By implementing a robust validation process, the system reduces the risk of misconfigurations, unauthorized access, and operational disruptions while continuously refining its decision-making capabilities using machine learning. Through automation and AI-enhanced security analysis, the system optimizes the enforcement of network security policies while maintaining adaptability to evolving cyber threats.

FIG. 4 illustrates an exemplary class diagram in accordance with one or more embodiments disclosed herein that represents the object-oriented architecture of an artificial intelligence-driven network rule validation system. The class diagram provides a detailed breakdown of the major components of the system, their attributes, methods, and interconnections. Each class is uniquely numbered, beginning with the rule validation engine (400), which serves as the entry point for receiving and processing proposed network rule changes. The rule validation engine (400) includes attributes such as rule_id, rule_parameters, submission_source, validation_status, and timestamp, which allow the system to track incoming rule modifications. The rule validation engine (400) has methods for receiving a rule change request, validating the format of the rule, storing it in the rule repository (404), and forwarding the rule data to the simulation engine (406) for further analysis.

The rule repository (404) serves as the centralized database for storing all network rule changes. It maintains attributes such as rule_database and version_control_enabled, which allow administrators to track historical rule modifications, enforce version control, and ensure that security policies remain consistent. The rule repository (404) provides methods for storing rules, retrieving previously implemented rules based on their rule_id, and tracking rule changes over time. The simulation engine (406) interacts with the rule repository (404) to retrieve existing network security configurations, which it uses to generate a simulated ruleset. The simulation engine (406) contains attributes such as simulated_ruleset and network_topology, which enable it to create a comprehensive representation of the network environment. Its methods include generating a simulated ruleset, retrieving the current network configuration, and forwarding the results to the conflict detection module (408).

The conflict detection module (408) is responsible for identifying potential conflicts between the proposed rule change and existing network security policies. It includes attributes such as detected_conflicts and toxic_combinations_found, which indicate whether the newly introduced rule creates contradictions or security vulnerabilities. The conflict detection module (408) contains methods for analyzing rule conflicts, identifying toxic rule combinations, and forwarding the conflict results to the risk assessment module (410) for further processing. The risk assessment module (410) extracts key security risk factors associated with the proposed rule change. Its attributes include extracted_risk_factors and risk_score, which quantify the security implications of the rule modification. The methods of the risk assessment module (410) include extracting risk factors from rule data and threat intelligence, computing a risk score, and sending the results to the artificial intelligence model (414).

The threat intelligence module (412) is a crucial component that retrieves real-time threat data from external sources. Its attributes include threat_database and external_feeds, which store collected intelligence data from sources such as cyber threat feeds, SIEM platforms, vulnerability databases, and cloud security monitoring services. The threat intelligence module (412) includes methods for retrieving real-time threat intelligence, parsing threat data, and forwarding security findings to the risk assessment module (410). Once the risk assessment module (410) has processed the extracted risk factors, it sends them to the artificial intelligence model (414), which performs advanced machine learning-driven risk analysis. The artificial intelligence model (414) contains attributes such as model_weights and training_data, which are used to refine the risk prediction model over time. Its methods include predicting risk scores for rule changes, refining the model with new data, and sending computed risk scores to the rule decision module (416).

The rule decision module (416) plays a pivotal role in determining whether a proposed rule change should be automatically approved, rejected, or flagged for further review. The rule decision module (416) includes the decision_status attribute, which stores the final determination for each rule modification. Its methods include determining the approval status of the rule based on its risk score and sending the decision to either the rule enforcement module (418) for implementation or the manual review (420) process for further assessment. If the risk score is classified as low, the rule decision module (416) sends the rule to the rule enforcement module (418), which includes an enforcement_status attribute that tracks whether the rule has been successfully applied to the live network security configuration. The rule enforcement module (418) has methods for applying rules to the network and logging enforcement actions for compliance tracking.

For rule changes that require manual review, the manual review (420) class ensures that security administrators are notified of flagged rule modifications. It includes the review_required attribute, which determines whether human intervention is needed before proceeding. The methods of the manual review (420) class include notifying security administrators of the flagged rule change and receiving manual approval or rejection decisions. If a rule requires further security analysis, the virtualized environment module (422) provides a test environment to simulate the deployment of the rule. The virtualized environment module (422) contains attributes such as test_results, which store the findings from the simulated environment. Its methods include simulating a rule change, generating synthetic traffic for analysis, and evaluating the rule's impact on network security.

The feedback module (424) generates detailed security impact reports based on the findings from the virtualized environment module (422). It includes an attribute called report_data, which contains structured information about the security risks associated with the proposed rule change. The feedback module (424) has methods for generating security impact reports and overlaying visual representations of security findings. The security impact report is then sent to the security administrator for review, who determines whether the rule change should be approved or rejected. Once a final decision is made, the rule enforcement module (418) applies the approved rule to the live network configuration, while the audit module (426) records all rule validation decisions for compliance tracking.

The audit module (426) includes an attribute called audit_log, which maintains a historical record of all rule modifications, approvals, rejections, and security impact assessments. It has methods for logging rule validation decisions and generating compliance reports for regulatory audits. The self-adaptive security module (428) dynamically updates network security policies based on emerging threats and compliance mandates. Its attributes include dynamic_policies, which store adaptive security configurations. The self-adaptive security module (428) has methods for updating security policies and applying compensating security controls in response to newly identified risks.

The machine learning module (430) continuously refines the artificial intelligence model (414) to improve risk prediction accuracy. Its attributes include training_dataset, which stores historical validation outcomes used to retrain the AI model. The machine learning module (430) has methods for training the AI model, refining risk predictions, and updating model parameters to enhance future decision-making.

The relationships between these classes define the system's architecture. The rule validation engine (400) is connected to the rule repository (404) to store proposed rules and is linked to the simulation engine (406) for further processing. The simulation engine (406) sends data to the conflict detection module (408), which communicates with the risk assessment module (410). The risk assessment module (410) is associated with both the threat intelligence module (412) and the artificial intelligence model (414), enabling comprehensive risk evaluation. The artificial intelligence model (414) provides risk scores to the rule decision module (416), which either approves the rule through the rule enforcement module (418) or sends it for manual review (420). Flagged rules are analyzed in the virtualized environment module (422) and further processed by the feedback module (424), while final decisions are recorded in the audit module (426). The self-adaptive security module (428) dynamically updates policies based on audit findings, and the machine learning module (430) continuously enhances the AI-driven risk assessment.

Thus, FIG. 4 represents a structured, scalable system architecture that integrates artificial intelligence, real-time threat intelligence, rule conflict detection, and security policy enforcement to ensure that network rule changes are validated with the highest level of security and compliance. By leveraging automated decision-making, machine learning, and administrator oversight, the system effectively mitigates risks, prevents misconfigurations, and adapts to evolving security challenges.

Pseudocode exemplars for implementing various aspects of this disclosure are set forth below with explanations for reference.

```
# Initialize system with security policies, network rules, and threat intelligence sources
Initialize AI_Model
Initialize Threat_Intelligence_Feed
Initialize Rule_Repository
Initialize Risk_Scoring_System
Initialize Anomaly_Detection_Module
Initialize Simulation_Engine
Initialize Visualization_Tool
Initialize Feedback_System
# Continuously fetch real-time threat intelligence
While System_Running:
  threat_data = Fetch_Threat_Intelligence( )
  Update_Threat_Intelligence_Feed(threat_data)
# Function to analyze a proposed rule change
Function Validate_Rule_Change(proposed_rule):
  simulated_ruleset = Generate_Simulated_Ruleset(proposed_rule,
Rule_Repository)
# Check for conflicts and toxic combinations
  If Detect_Conflicts(simulated_ruleset):
    Return “Rule Change Rejected: Conflict Detected”
# Integrate with threat intelligence sources
  threat_analysis = Assess_Threat_Impact(proposed_rule, Threat_Intelligence_Feed)
# Assign risk score based on historical data and AI predictions
  risk_score = Compute_Risk_Score(proposed_rule, threat_analysis, AI_Model)
# Determine rule approval based on risk assessment
  If risk_score > HIGH_RISK_THRESHOLD:
    Return “Rule Change Rejected: High Risk”
  Else If risk_score > MEDIUM_RISK_THRESHOLD:
    Notify_Admin(proposed_rule, risk_score)
    Return “Rule Change Pending Review”
  Else:
    Apply_Rule_Change(proposed_rule)
    Return “Rule Change Approved”
# Function to detect conflicts within rule permutations
Function Detect_Conflicts(simulated_ruleset):
  For each rule_pair in simulated_ruleset:
    If Check_Rule_Interaction(rule_pair) == TOXIC_COMBINATION:
      Return True
  Return False
# Function to assess the security impact of a rule
Function Assess_Threat_Impact(proposed_rule, threat_data):
  correlated_threats = Find_Rule_Threat_Correlations(proposed_rule, threat_data)
  If correlated_threats:
    Return Compute_Threat_Severity(correlated_threats)
  Else:
    Return LOW_THREAT
# Function to compute risk score using AI model
Function Compute_Risk_Score(proposed_rule, threat_analysis, AI_Model):
  risk_factors = Extract_Risk_Factors(proposed_rule, threat_analysis)
  risk_score = AI_Model.Predict_Risk(risk_factors)
  Return risk_score
# Function to simulate rule changes in a virtual environment
Function Generate_Simulated_Ruleset(proposed_rule, Rule_Repository):
  simulated_env = Create_Virtual_Environment( )
  For each rule in Rule_Repository:
    Apply_Rule(simulated_env, rule)
  Apply_Rule(simulated_env, proposed_rule)
  Return simulated_env
# Function to apply rule changes to live network
Function Apply_Rule_Change(proposed_rule):
  Log_Change(proposed_rule)
  Implement_Rule(proposed_rule)
  Notify_Stakeholders(proposed_rule)
# Function to provide real-time feedback
Function Notify_Admin(proposed_rule, risk_score):
  feedback_message = Generate_Feedback(proposed_rule, risk_score)
  Send_Notification(Admin_Contact, feedback_message)
# Function to visualize rule dependencies
Function Generate_Visualization(simulated_ruleset):
  Create_Graph(simulated_ruleset)
  Display_Visualization( )
# System continuously updates itself using machine learning
While System_Running:
  AI_Model.Train_On_Historical_Data(Rule_Repository, Security_Incidents)
  Anomaly_Detection_Module.Update_Models( )
  Risk_Scoring_System.Adjust_Thresholds( )
```

The pseudocode begins by initializing the core components of the system, including the AI model, rule repository, threat intelligence feed, risk scoring system, anomaly detection module, simulation engine, visualization tool, and feedback system. These components work together to assess the security implications of proposed network rule changes and ensure they do not introduce vulnerabilities.

The system operates in real time, continuously fetching updated threat intelligence from external sources. This ensures that the latest cyber threat data is available to enhance rule validation. The fetched data is updated in the system's threat intelligence feed, allowing it to assess proposed rule changes against newly emerging threats.

When a proposed rule change is submitted, it undergoes validation through multiple stages. The system first generates a simulated rule set by incorporating the proposed rule into the existing repository and modeling its interactions with all active rules. It then detects conflicts and toxic rule combinations by analyzing rule interactions. If any conflicts are found, the rule change is immediately rejected.

The system then performs a threat impact assessment by cross-referencing the proposed rule with external threat intelligence data. If the rule aligns with any known vulnerabilities, targets, or attack patterns, the system computes a threat severity level to quantify its risk. The computed threat assessment is then used as an input to the AI-driven risk scoring mechanism.

The risk scoring system extracts various risk factors from the proposed rule and the correlated threat intelligence data. The AI model evaluates these factors and predicts a risk score based on historical attack data and previous rule modifications. The computed risk score determines whether the rule is automatically approved, flagged for review, or rejected. If the risk score exceeds a predefined high-risk threshold, the rule is rejected outright. If the score is within a medium-risk range, the system notifies an administrator for manual review. If the risk score is low, the rule is automatically applied.

To prevent misconfigurations, the system allows administrators to test rule changes in a virtualized simulation environment before deployment. The system creates a simulated network where all existing rules are applied, followed by the proposed modification. This ensures that unintended security gaps or traffic disruptions are detected before they can affect live network traffic.

Once a rule change is approved, the system logs the modification, implements the rule in the live network, and notifies relevant stakeholders. This ensures transparency and accountability in the rule change process. The system also provides real-time feedback through a detailed risk assessment report. If a rule is flagged or rejected, administrators receive an explanation along with suggested alternative configurations to achieve the same functional goal without compromising security.

An advanced visualization tool provides an intuitive graphical representation of rule dependencies, interactions, and risk levels. This helps network administrators understand how rule modifications impact the broader security framework. By displaying conflicts and security gaps visually, the system enhances decision-making and reduces the likelihood of oversights.

The system continuously improves its decision-making capabilities through machine learning. It trains on historical rule data and security incident reports, refining its AI models to detect new risks more accurately. The anomaly detection module updates itself regularly to identify emerging threats, while the risk scoring system dynamically adjusts its thresholds based on evolving security trends.

By automating the validation, risk assessment, and approval of network rule changes, the invention ensures that modifications do not introduce vulnerabilities or conflicts. Through AI-driven analysis, simulation-based testing, and integration with real-time threat intelligence, the system significantly enhances network security and operational efficiency. This approach minimizes manual workload, reduces human error, and enables organizations to maintain a strong and adaptive security posture against evolving cyber threats.

A skilled artisan, upon reviewing the disclosure, will appreciate that there are numerous alternatives, modifications, combinations, and customizations that can be made to the systems and methods described herein.

The systems and methods described herein may be adapted, modified, combined, and customized in a variety of ways while remaining within the spirit and scope of the disclosure. Various alternatives exist for implementing the AI-driven network rule validation system, including different architectures, machine learning techniques, data sources, and integration approaches. The core framework of this invention can be extended or altered to accommodate various security infrastructures, operational environments, and compliance requirements.

One alternative implementation involves using a distributed or decentralized architecture for rule validation rather than a centralized processing system. In this approach, rule validation can be performed using edge computing resources or within distributed network nodes to improve scalability and reduce latency. Each network segment could have a localized instance of the validation engine, which synchronizes with a central repository while allowing real-time processing at individual network endpoints.

Modifications can be made to the AI and machine learning models used for risk assessment and anomaly detection. Instead of relying on a single AI model, an ensemble of models such as deep neural networks, decision trees, and Bayesian networks can be used to improve risk prediction accuracy. Different machine learning techniques, including unsupervised learning for anomaly detection, reinforcement learning for adaptive rule enforcement, and federated learning for privacy-preserving model training, can also be incorporated.

Alternative threat intelligence integration mechanisms can be employed to enhance the system's ability to assess risks. Instead of relying solely on external threat feeds, the system could incorporate crowd-sourced intelligence from industry-specific cybersecurity communities. Additionally, blockchain-based threat intelligence sharing can be utilized to ensure data integrity and reduce reliance on centralized data sources. Customized data enrichment techniques, such as natural language processing for extracting threat intelligence from unstructured reports, may also be integrated.

A key customization is adapting the system to different network environments, such as cloud-native infrastructures, software-defined networks (SDN), and Internet of Things (IoT) ecosystems. For cloud security, the system could interface directly with cloud-native security tools like AWS Security Hub or Azure Sentinel to evaluate rule changes in real-time cloud workloads. In SDN environments, the system could communicate directly with the SDN controller to dynamically enforce and validate security policies at the network layer. For IoT deployments, lightweight rule validation agents could be implemented on edge devices to ensure that security policies are enforced even in resource-constrained environments.

Combinations with other security tools and frameworks can extend the capabilities of the system. The AI-based validation engine can be integrated with security orchestration, automation, and response (SOAR) platforms to automate incident response workflows. The system could also work in conjunction with deception technology by analyzing simulated attack attempts to refine its rule validation mechanisms. Additionally, integration with zero-trust security frameworks can ensure that rule changes align with strict access control policies.

Alternative user interfaces and visualization tools can be incorporated to improve administrator usability and security oversight. Instead of static reports, the system could generate interactive dashboards with augmented reality (AR) or virtual reality (VR) capabilities, allowing security teams to visualize network rule dependencies in an immersive environment. Customization options can be added to tailor dashboard components based on specific user roles, such as network administrators, compliance officers, and security analysts.

Another possible modification is to implement an intent-based networking (IBN) framework where network administrators define security policies based on high-level intent rather than low-level rule configurations. The system could translate these policies into optimized firewall rules, access control lists, and network segmentation policies while continuously validating compliance with intent-based security models. This would reduce the complexity of rule management while ensuring policy adherence.

The system can also be customized for specific regulatory compliance requirements, such as GDPR, PCI-DSS, HIPAA, and NIST standards. Compliance modules could be added to automatically check whether a proposed rule change aligns with industry regulations and provide compliance documentation for audit purposes. By incorporating automated policy auditing, the system can streamline governance processes for enterprises operating in highly regulated industries.

Another customization involves refining the rule validation workflow to allow different levels of automation based on organizational risk tolerance. For example, organizations with a high-security posture may prefer strict enforcement, where only pre-approved AI-validated rules are allowed, whereas organizations requiring more flexibility may configure the system to allow human override options for certain rule changes. This would allow for a balance between security automation and human decision-making.

A further enhancement includes integrating natural language processing (NLP) capabilities to allow administrators to propose rule changes in human-readable formats. Instead of manually configuring firewall rules, an administrator could input a request such as “Allow internal users to access the finance database securely,” and the system would generate and validate the corresponding rule set automatically. This customization simplifies policy definition and reduces the risk of misconfigurations due to syntax errors.

Additionally, alternative risk scoring models can be employed based on industry-specific risk profiles. Instead of using a generic risk assessment methodology, financial institutions and government agencies could have tailored risk models that consider sector-specific threat landscapes and compliance needs. AI models can be trained on domain-specific datasets to provide more accurate risk assessments relevant to each industry.

Another combination involves integrating behavioral analytics to enhance the anomaly detection component of the system. By continuously analyzing network user behavior, the system can detect deviations from normal activity patterns that indicate potential insider threats or credential compromise. The AI model could then automatically adjust security rules based on detected behavioral anomalies to prevent unauthorized access attempts.

Future modifications could also include adaptive policy enforcement mechanisms where security rules evolve dynamically in response to detected threats. Instead of manually updating rule configurations, the system could automatically adjust firewall rules, intrusion detection parameters, and access control lists in near real-time as new threats emerge. This would enable organizations to implement a truly adaptive security architecture that continuously evolves to counteract modern cyber threats.

Additionally, the system could be extended to operate in multi-tenant environments, where a centralized rule validation engine provides security policy enforcement across multiple independent organizations. This would be particularly useful for managed security service providers (MSSPs) offering security rule validation as a service. Multi-tenancy capabilities would ensure that different organizations maintain isolated rule repositories while benefiting from shared threat intelligence and validation frameworks.

Another possible enhancement is the incorporation of automated remediation workflows that respond to security incidents triggered by misconfigurations. If a validated rule change inadvertently introduces a security risk that is later detected through real-world network activity, the system could automatically revert the change, apply compensating controls, or trigger an incident response workflow to mitigate the risk before it is targeted.

Finally, alternative deployment models could be explored, such as offering the AI-based rule validation system as a cloud-based service, an on-premises appliance, or a hybrid SaaS model. A cloud-based deployment would enable organizations to leverage centralized AI processing and threat intelligence without requiring extensive on-site hardware, while an on-premises model would appeal to highly secure environments that require full control over network validation processes. Hybrid deployment models would allow organizations to use local validation for critical infrastructure while leveraging cloud-based AI models for advanced threat detection.

By implementing these alternatives, modifications, combinations, and customizations, the invention can be adapted to various operational requirements, security needs, and technological advancements. These enhancements ensure that the AI-driven rule validation system remains scalable, flexible, and capable of addressing the evolving challenges of modern cybersecurity landscapes.

Although the present technology has been described based on what is currently considered the most practical and preferred implementations, it is to be understood that this detail is only for that purpose and this disclosure is not limited to the sample descriptions and implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

1. A computer-implemented method for validating network rule changes using artificial intelligence, the method comprising:
receiving, by a rule validation engine executed by at least one processor, a proposed network rule change to a network security configuration;
generating, by a simulation engine executed by the at least one processor, a simulated ruleset by applying the proposed network rule change to an existing network security configuration stored in a rule repository;
analyzing, by a conflict detection module executed by the at least one processor, the simulated ruleset to detect conflicts between the proposed network rule change and existing security rules, wherein detecting the conflicts comprises identifying toxic rule combinations that create security vulnerabilities;
retrieving, by a threat intelligence module executed by the at least one processor, real-time threat intelligence data from at least one external threat intelligence source;
correlating, by a threat impact analysis module executed by the at least one processor, the proposed network rule change with the real-time threat intelligence data to determine whether the proposed network rule change increases exposure to known security threats;
extracting, by a risk assessment module executed by the at least one processor, a set of risk factors from the proposed network rule change, the detected conflicts, and the correlated threat intelligence data;
computing, by an artificial intelligence model executed by the at least one processor, a risk score for the proposed network rule change based on the extracted risk factors, wherein computing the risk score comprises analyzing historical rule modifications, past security incidents, and previously detected vulnerabilities;
determining, by a rule decision module executed by the at least one processor, an approval status for the proposed network rule change based on the risk score, wherein the approval status is selected from an approval status group consisting of:
(i) automatic approval of the proposed network rule change when the risk score is below a predefined low-risk threshold,
(ii) automatic rejection of the proposed network rule change when the risk score exceeds a predefined high-risk threshold, and
(iii) flagging the proposed network rule change for manual review when the risk score falls within a predefined medium-risk range;
simulating, by a virtualized environment module executed by the at least one processor, a deployment of the proposed network rule change in a virtualized test environment when the proposed network rule change is flagged for manual review, wherein simulating the deployment comprises monitoring for unintended traffic disruptions, security vulnerabilities, or policy violations;
presenting, by a visualization module executed by the at least one processor, a graphical representation of the proposed network rule change, the detected conflicts, and the computed risk score, wherein the graphical representation illustrates rule dependencies, risk levels, and affected network segments;
· generating, by a feedback module executed by the at least one processor, an automated report describing the security implications of the proposed network rule change, wherein the automated report comprises a justification for the approval status, a list of identified conflicts, a summary of correlated threat intelligence, and at least one recommended mitigation strategy when the proposed network rule change is flagged for manual review or rejected;
transmitting, by a notification module executed by the at least one processor, the automated report to at least one security administrator for further review when the proposed network rule change is flagged for manual review or rejected;
implementing, by a rule enforcement module executed by the at least one processor, the proposed network rule change in the network security configuration when the proposed network rule change is automatically approved or manually approved following a review by the at least one security administrator;
logging, by an audit module executed by the at least one processor, the implemented network rule change along with the associated risk score, approval status, and any detected conflicts for compliance tracking and forensic analysis;
continuously training, by a machine learning module executed by the at least one processor, the artificial intelligence model using historical rule change data, detected security incidents, and evolving threat intelligence to refine future risk assessments and rule validation decisions; and
updating, by a self-adaptive security module executed by the at least one processor, network security policies dynamically based on newly identified threats, security vulnerabilities, and changes in regulatory compliance requirements.

2. The method of claim 1, wherein retrieving the real-time threat intelligence data further comprises parsing structured and unstructured threat data from at least one external source selected from a group consisting of: a cyber threat intelligence feed, a vulnerability database, a security information and event management (SIEM) system, a cloud security monitoring service, and a machine-readable threat intelligence standard.

3. The method of claim 2, wherein correlating the proposed network rule change with the real-time threat intelligence data further comprises identifying whether the proposed network rule change aligns with at least one known attack technique, tactic, or procedure from the MITRE ATT&CK framework.

4. The method of claim 3, wherein computing the risk score further comprises applying a weighted scoring model that assigns a higher risk value to proposed network rule changes that increase susceptibility to at least one of lateral movement, unauthorized data exfiltration, denial-of-service attacks, privilege escalation, or command and control activity.

5. The method of claim 4, wherein determining the approval status for the proposed network rule change further comprises dynamically adjusting the predefined low-risk, medium-risk, and high-risk thresholds based on at least one of an organization's security policy, a predefined risk tolerance setting, or recent security incidents affecting the network.

6. The method of claim 5, wherein simulating the deployment of the proposed network rule change in the virtualized test environment further comprises generating synthetic network traffic to model real-world usage scenarios and identifying whether the proposed network rule change introduces latency, packet loss, or unintended traffic redirection.

7. The method of claim 6, wherein presenting the graphical representation of the proposed network rule change further comprises overlaying real-time network traffic patterns, security alerts, and historical rule change data to provide contextual insights into how the proposed network rule change interacts with existing network conditions.

8. The method of claim 7, wherein generating the automated report further comprises including a confidence level score indicating the reliability of the risk assessment, wherein the confidence level score is derived from an uncertainty analysis of historical AI model predictions, recent changes in threat intelligence data, and variance in detected security incidents.

9. The method of claim 8, wherein logging the implemented network rule change further comprises generating a digitally signed cryptographic record of the rule change, the risk score, and the approval status to ensure integrity, authenticity, and non-repudiation of security policy modifications.

10. The method of claim 9, wherein updating the network security policies dynamically further comprises automatically generating at least one compensating security control in response to an identified high-risk rule change, wherein the compensating security control is selected from a group consisting of: a temporary firewall rule adjustment, an adaptive access control modification, a security monitoring rule enhancement, and a privileged user access restriction.

11. A computer-implemented method for validating network rule changes using artificial intelligence, the method comprising:
receiving, by a rule validation engine executed by at least one processor, a proposed network rule change to a network security configuration;
generating, by a simulation engine executed by the at least one processor, a simulated ruleset by applying the proposed network rule change to an existing network security configuration stored in a rule repository;
analyzing, by a conflict detection module executed by the at least one processor, the simulated ruleset to detect conflicts between the proposed network rule change and existing security rules, wherein detecting the conflicts comprises identifying toxic rule combinations that create security vulnerabilities;
retrieving, by a threat intelligence module executed by the at least one processor, real-time threat intelligence data from at least one external threat intelligence source, wherein retrieving the real-time threat intelligence data further comprises parsing structured and unstructured threat data from at least one external source selected from a group consisting of: a cyber threat intelligence feed, a vulnerability database, a security information and event management (SIEM) system, a cloud security monitoring service, and a machine-readable threat intelligence standard;
correlating, by a threat impact analysis module executed by the at least one processor, the proposed network rule change with the real-time threat intelligence data to determine whether the proposed network rule change increases exposure to known security threats, wherein correlating the proposed network rule change with the real-time threat intelligence data further comprises identifying whether the proposed network rule change aligns with at least one known attack technique, tactic, or procedure from the MITRE ATT&CK framework;
extracting, by a risk assessment module executed by the at least one processor, a set of risk factors from the proposed network rule change, the detected conflicts, and the correlated threat intelligence data;
computing, by an artificial intelligence model executed by the at least one processor, a risk score for the proposed network rule change based on the extracted risk factors, wherein computing the risk score further comprises applying a weighted scoring model that assigns a higher risk value to proposed network rule changes that increase susceptibility to at least one of lateral movement, unauthorized data exfiltration, denial-of-service attacks, privilege escalation, or command and control activity;
determining, by a rule decision module executed by the at least one processor, an approval status for the proposed network rule change based on the risk score, wherein determining the approval status further comprises dynamically adjusting predefined low-risk, medium-risk, and high-risk thresholds based on at least one of an organization's security policy, a predefined risk tolerance setting, or recent security incidents affecting the network, and wherein the approval status is selected from an approval status group consisting of:
(i) automatic approval of the proposed network rule change when the risk score is below the predefined low-risk threshold,
(ii) automatic rejection of the proposed network rule change when the risk score exceeds the predefined high-risk threshold, and
(iii) flagging the proposed network rule change for manual review when the risk score falls within the predefined medium-risk range;
simulating, by a virtualized environment module executed by the at least one processor, a deployment of the proposed network rule change in a virtualized test environment when the proposed network rule change is flagged for manual review, wherein simulating the deployment further comprises generating synthetic network traffic to model real-world usage scenarios and identifying whether the proposed network rule change introduces latency, packet loss, or unintended traffic redirection;
presenting, by a visualization module executed by the at least one processor, a graphical representation of the proposed network rule change, the detected conflicts, and the computed risk score, wherein presenting the graphical representation further comprises overlaying real-time network traffic patterns, security alerts, and historical rule change data to provide contextual insights into how the proposed network rule change interacts with existing network conditions;
generating, by a feedback module executed by the at least one processor, an automated report describing the security implications of the proposed network rule change, wherein generating the automated report further comprises including a confidence level score indicating the reliability of the risk assessment, wherein the confidence level score is derived from an uncertainty analysis of historical artificial intelligence model predictions, recent changes in threat intelligence data, and variance in detected security incidents;
transmitting, by a notification module executed by the at least one processor, the automated report to at least one security administrator for further review when the proposed network rule change is flagged for manual review or rejected;
implementing, by a rule enforcement module executed by the at least one processor, the proposed network rule change in the network security configuration when the proposed network rule change is automatically approved or manually approved following a review by the at least one security administrator;
logging, by an audit module executed by the at least one processor, the implemented network rule change along with the associated risk score, approval status, and any detected conflicts for compliance tracking and forensic analysis, wherein logging the implemented network rule change further comprises generating a digitally signed cryptographic record of the rule change, the risk score, and the approval status to ensure integrity, authenticity, and non-repudiation of security policy modifications;
continuously training, by a machine learning module executed by the at least one processor, the artificial intelligence model using historical rule change data, detected security incidents, and evolving threat intelligence to refine future risk assessments and rule validation decisions; and
updating, by a self-adaptive security module executed by the at least one processor, network security policies dynamically based on newly identified threats, security vulnerabilities, and changes in regulatory compliance requirements, wherein updating the network security policies dynamically further comprises automatically generating at least one compensating security control in response to an identified high-risk rule change, wherein the compensating security control is selected from a group consisting of: a temporary firewall rule adjustment, an adaptive access control modification, a security monitoring rule enhancement, and a privileged user access restriction.

12. A system for validating network rule changes using artificial intelligence, the system comprising:
a rule validation engine executed by at least one processor and configured to receive a proposed network rule change to a network security configuration;
a simulation engine executed by the at least one processor and configured to generate a simulated ruleset by applying the proposed network rule change to an existing network security configuration stored in a rule repository;
a conflict detection module executed by the at least one processor and configured to analyze the simulated ruleset to detect conflicts between the proposed network rule change and existing security rules, wherein detecting the conflicts comprises identifying toxic rule combinations that create security vulnerabilities;
a threat intelligence module executed by the at least one processor and configured to retrieve real-time threat intelligence data from at least one external threat intelligence source, wherein retrieving the real-time threat intelligence data further comprises parsing structured and unstructured threat data from at least one external source selected from a group consisting of: a cyber threat intelligence feed, a vulnerability database, a security information and event management (SIEM) system, a cloud security monitoring service, and a machine-readable threat intelligence standard;
a threat impact analysis module executed by the at least one processor and configured to correlate the proposed network rule change with the real-time threat intelligence data to determine whether the proposed network rule change increases exposure to known security threats, wherein correlating the proposed network rule change with the real-time threat intelligence data further comprises identifying whether the proposed network rule change aligns with at least one known attack technique, tactic, or procedure from the MITRE ATT&CK framework;
a risk assessment module executed by the at least one processor and configured to extract a set of risk factors from the proposed network rule change, the detected conflicts, and the correlated threat intelligence data;
an artificial intelligence model executed by the at least one processor and configured to compute a risk score for the proposed network rule change based on the extracted risk factors, wherein computing the risk score further comprises applying a weighted scoring model that assigns a higher risk value to proposed network rule changes that increase susceptibility to at least one of lateral movement, unauthorized data exfiltration, denial-of-service attacks, privilege escalation, or command and control activity;
a rule decision module executed by the at least one processor and configured to determine an approval status for the proposed network rule change based on the risk score, wherein determining the approval status further comprises dynamically adjusting predefined low-risk, medium-risk, and high-risk thresholds based on at least one of an organization's security policy, a predefined risk tolerance setting, or recent security incidents affecting the network, and wherein the approval status is selected from an approval status group consisting of:
(i) automatic approval of the proposed network rule change when the risk score is below the predefined low-risk threshold,
(ii) automatic rejection of the proposed network rule change when the risk score exceeds the predefined high-risk threshold, and
(iii) flagging the proposed network rule change for manual review when the risk score falls within the predefined medium-risk range;
a virtualized environment module executed by the at least one processor and configured to simulate a deployment of the proposed network rule change in a virtualized test environment when the proposed network rule change is flagged for manual review, wherein simulating the deployment further comprises generating synthetic network traffic to model real-world usage scenarios and identifying whether the proposed network rule change introduces latency, packet loss, or unintended traffic redirection;
a visualization module executed by the at least one processor and configured to present a graphical representation of the proposed network rule change, the detected conflicts, and the computed risk score, wherein presenting the graphical representation further comprises overlaying real-time network traffic patterns, security alerts, and historical rule change data to provide contextual insights into how the proposed network rule change interacts with existing network conditions;
a feedback module executed by the at least one processor and configured to generate an automated report describing the security implications of the proposed network rule change, wherein generating the automated report further comprises including a confidence level score indicating the reliability of the risk assessment, wherein the confidence level score is derived from an uncertainty analysis of historical artificial intelligence model predictions, recent changes in threat intelligence data, and variance in detected security incidents;
a notification module executed by the at least one processor and configured to transmit the automated report to at least one security administrator for further review when the proposed network rule change is flagged for manual review or rejected;
a rule enforcement module executed by the at least one processor and configured to implement the proposed network rule change in the network security configuration when the proposed network rule change is automatically approved or manually approved following a review by the at least one security administrator;
an audit module executed by the at least one processor and configured to log the implemented network rule change along with the associated risk score, approval status, and any detected conflicts for compliance tracking and forensic analysis, wherein logging the implemented network rule change further comprises generating a digitally signed cryptographic record of the rule change, the risk score, and the approval status to ensure integrity, authenticity, and non-repudiation of security policy modifications;
a machine learning module executed by the at least one processor and configured to continuously train the artificial intelligence model using historical rule change data, detected security incidents, and evolving threat intelligence to refine future risk assessments and rule validation decisions; and
a self-adaptive security module executed by the at least one processor and configured to update network security policies dynamically based on newly identified threats, security vulnerabilities, and changes in regulatory compliance requirements, wherein updating the network security policies dynamically further comprises automatically generating at least one compensating security control in response to an identified high-risk rule change, wherein the compensating security control is selected from a group consisting of: a temporary firewall rule adjustment, an adaptive access control modification, a security monitoring rule enhancement, and a privileged user access restriction.

13. The system of claim 12, wherein the threat intelligence module is further configured to retrieve real-time threat intelligence data from multiple external sources and apply a relevance filtering mechanism that prioritizes threat intelligence sources based on historical accuracy, source credibility, and contextual applicability to the network security configuration.

14. The system of claim 13, wherein the risk assessment module is further configured to apply a multi-layered scoring model that assigns separate risk scores for different categories of security threats, including unauthorized access risks, data exfiltration risks, network availability risks, and privilege escalation risks, wherein the highest risk score among the categories determines the overall risk score for the proposed network rule change.

15. The system of claim 14, wherein the rule decision module is further configured to incorporate adaptive policy weighting factors into the approval status determination, wherein the adaptive policy weighting factors adjust the impact of specific risk categories based on organizational security priorities, regulatory compliance requirements, or recently observed attack patterns.

16. The system of claim 15, wherein the virtualized environment module is further configured to generate a multi-scenario simulation by modeling different traffic patterns, attack simulations, and system load conditions to assess how the proposed network rule change impacts security and performance under varying operational conditions.

17. The system of claim 16, wherein the visualization module is further configured to provide an interactive user interface that allows network administrators to dynamically explore rule dependencies, simulate alternative security configurations, and visualize the projected impact of potential rule modifications in real-time.

18. The system of claim 17, wherein the feedback module is further configured to generate mitigation recommendations for proposed network rule changes that are flagged for manual review or rejection, wherein the mitigation recommendations suggest alternative rule configurations, additional compensating security controls, or policy modifications to achieve the intended security objectives while reducing identified risks.

19. The system of claim 18, wherein the audit module is further configured to generate compliance audit reports that document all rule change decisions, associated risk scores, detected conflicts, and applied security mitigations, wherein the compliance audit reports are formatted in accordance with at least one industry cybersecurity framework selected from a group consisting of NIST, ISO 27001, PCI-DSS, and GDPR.

20. The system of claim 19, wherein the self-adaptive security module is further configured to dynamically update access control policies, network segmentation rules, and anomaly detection thresholds in response to real-time security intelligence updates, wherein the self-adaptive security module continuously refines security policies to align with evolving cyber threat landscapes.
